(19) United States
(12) Patent Application Publication
(10) Pub. No.: US 2010/0033540 A1
(43) Pub. Date: Feb. 11, 2010

(54) DROPLET DISCHARGE HEAD, DROPLET DISCHARGE DEVICE, AND METHOD FOR MANUFACTURING DROPLET DISCHARGE HEAD

(75) Inventors: Tomonori MATSUSHITA, Fujimi (JP); Kazufumi OYA, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/535,079

(22) Filed: Aug. 4, 2009

(30) Foreign Application Priority Data
Aug. 5, 2008 (JP) 2008-202303

(51) Int. Cl. B41J 2/045

(52) U.S. Cl. 347/70

(57) ABSTRACT

A droplet discharge head, includes: a nozzle substrate having a plurality of nozzles, each of the plurality of nozzles discharging a droplet; a cavity substrate including a discharge chamber communicating with the nozzle and having a vibration plate formed at part thereof, an individual electrode that is formed to the vibration plate and is provided in a plurality of numbers so that each individual electrode corresponds to one of the nozzles, and an insulation layer formed between the individual electrodes; an electrode substrate having a common electrode formed at a position facing the vibration plate; and a member sandwiched between the cavity substrate and the electrode substrate so as to form a gap.

### CROSS-REFERENCE TO RELATED APPLICATION

This application is based on and claims priority from Japanese Patent Application No. 2008-202303, filed on Aug. 5, 2008, the contents of which are incorporated herein by reference

### BACKGROUND

1. Technical Field

The present invention relates to a droplet discharge head, a droplet discharge device having the droplet discharge head mounted therein, and a method for manufacturing the droplet discharge head.

2. Related Art

As a droplet discharge head used to discharge droplets, an inkjet head mounted to a device such as an inkjet recording device is known. An inkjet head generally includes a nozzle substrate having a plurality of nozzle holes formed therein for discharging ink droplets, and a cavity substrate having a discharge chamber bonded to the nozzle substrate so as to communicate with the nozzle holes in the nozzle substrate and an ink flow path such as a reservoir. The inkjet head discharges an ink droplet from a selected nozzle hole by applying pressure to the discharge chamber from a driving section. Examples of the driving systems include a system using an electrostatic force, a piezoelectric system using piezoelectric elements, and a bubble jet (registered trade mark) system using heating elements.

An example of the inkjet head using the electrostatic force is structured as follows: a bottom wall of a discharge chamber serves as a vibration plate, and an electrode is formed on a glass substrate so as to face the vibration plate with a predetermined gap (space) interposed therebetween. The electrode is formed as a film on a bottom surface of a recessed section (hereinafter, referred to as electrode-forming recessed section) formed on a surface of the glass substrate with an electrode material such as indium tin oxide (ITO) in order to ensure a predetermined gap length. Refer to JP-A-2003-118127.

Recently, there has been an increasing demand for the inkjet head to provide high quality printing, images, and the like. An inkjet head is, thus, demanded that discharges ink at a stable amount from nozzles and enables nozzles and discharge chambers to be disposed in high density as well as in multiple lines.

In order to meet such demand, it is required that an electrode-forming recessed section disposed to face the discharge chamber is formed with high accuracy. For example, to meet a high quality printing demand, it is required to stabilize a discharge amount of ink discharged from each nozzle. The ink discharge amount is influenced by a distance between the bottom wall (vibration plate) of the discharge chamber and the electrode formed in the electrode-forming recessed section. Therefore, in order to stabilize the ink discharge amount discharged from each nozzle, the depth (the gap length between the vibration plate and the electrode) of each electrode-forming recessed section needs to be formed with high accuracy. As another example, in order to dispose the discharge chamber as well as the electrode-forming recessed section disposed to face the discharge chamber in high density, the discharge chamber and the electrode-forming recessed section needs to be positioned with high accuracy. Therefore, the width dimension and position of the electrode-forming recessed section needs to be formed with high accuracy.

It is difficult, however, to form the electrode-forming recessed section with high accuracy because the electrode-forming recessed section of the electrode substrate is generally formed by etching with hydrofluoric acid. This etching causes a large variation in shape and positional accuracy of the electrode-forming recessed section. Thus, there has been a problem in that it is difficult to stabilize the ink discharge amount of each nozzle, and to dispose the nozzles and discharge chambers in high density as well as in a multiple lines.

### SUMMARY

An advantage of the invention is to provide a droplet discharge head that enables each nozzle to discharge ink at stable amount, and nozzles and discharge chambers to be disposed in high density as well as in multiple lines, a droplet discharge device including the droplet discharge head mounted therein, and a method for manufacturing the droplet discharge head.

According to a first aspect of the invention, a droplet discharge head includes: a nozzle substrate having a plurality of nozzles discharging a droplet; a cavity substrate having a plurality of discharge chambers each of which communicate with one of the nozzles and has bottom walls serving as vibration plates, a plurality of individual electrodes each of which is formed to one of the vibration plates, and an insulation layer formed between the individual electrodes; an electrode substrate having a common electrode formed at least in an area facing the vibration plates; and a spacer layer disposed between the cavity substrate and the electrode substrate to form gaps between the vibration plates and the common electrode.

According to the invention, forming the spacer layer as a film enables a gap length between the vibration plate (individual electrode) and the common electrode to be formed with high accuracy. In addition, the opening of the space layer can be formed with high accuracy. The opening corresponds to the electrode-forming recessed section in related art droplet discharge head. Thus, a droplet discharge head can be provided that enables each nozzle to discharge ink at stable amount, and nozzles and discharge chambers to be disposed in high density as well as in multiple lines. In addition, the insulation layer provided between the individual electrodes can prevent a malfunction of the droplet discharge head since electrical conduction does not occur between the individual electrodes (the vibration plates).

In the droplet discharge head, the width of the insulation layer may be larger than that of a partition wall between the discharge chambers. This structure can firmly prevent an electrical conduction between the individual electrodes (vibration plates) from occurring as well as further prevent a malfunction of the droplet discharge head from occurring.

In the droplet discharge head, a common electrode side insulation layer may be formed on a surface of the common electrode to prevent a short between the individual electrode and the common electrode from occurring. According to the invention, the insulation layer can be formed on the surface of the common electrode to have good insulation property without having any coverage defects since the common electrode has the surface of a flat-shape.

In the droplet discharge head, an individual electrode lead section may be formed on a face, facing the cavity substrate, of the electrode substrate. The individual electrode lead section is coupled to the individual electrode when the electrode substrate and the cavity substrate are joined. This structure allows the individual electrode and the individual electrode lead section to be coupled only by positioning the electrode substrate and the cavity substrate and joining them. As a result, the individual electrode and the driver IC are readily coupled.

According to a second aspect of the invention, a droplet discharge device includes the droplet discharge head of the first aspect.

According to the invention, since the droplet discharge device includes the droplet discharge head, the droplet discharge device shows a good discharge performance. For example, high quality images can be provided when the device is used for image printing.

According to a third aspect of the invention, a method for manufacturing the droplet discharge head includes a step to form individual electrodes to a face, facing an electrode substrate, of a cavity substrate; a step to form an insulation layer between the individual electrodes; a step to form a common electrode and a spacer layer as films to a face, facing the cavity substrate, of the electrode substrate; and a step to join the cavity substrate and the electrode substrate. According to the invention, since the spacer layer can be formed as a film, a gap length between the individual electrode serving as the vibration plate and the common electrode can be formed with high accuracy. In addition, the opening of the spacer layer can be formed with high accuracy. The opening corresponds to the electrode-forming recessed section. As a result, a droplet discharge head can be provided that enables nozzles and discharge chambers to be disposed in high density as well as in multiple lines.

### BRIEF DESCRIPTION OF THE DRAWINGS

The invention will be described with reference to the accompanying drawings, wherein like numbers reference like elements.

FIG. 1 is an exploded perspective view showing a droplet discharge head according to a first embodiment of the invention.

FIG. 2 is a longitudinal sectional view of the droplet discharge head of the first embodiment.

FIG. 3 is a longitudinal sectional view of the droplet discharge head of the first embodiment in the widthwise direction.

FIG. 4 is a top view of the droplet discharge head of the first embodiment.

FIGS. 5A to 5E are sectional views showing manufacturing steps of an electrode substrate according to the first embodiment.

FIGS. 6F to 6H are sectional views showing the manufacturing steps after FIGS. 5A to 5E.

FIGS. 7A to 7E are sectional views showing manufacturing steps of a cavity substrate and the droplet discharge head according to the first embodiment.

FIGS. 8F to 8I are sectional views showing the manufacturing steps after FIGS. 7A to 7E.

FIGS. 9J and 9K are sectional views showing the manufacturing steps after FIGS. 8F to 8I.

FIG. 10 is an external view showing a droplet discharge device employing the droplet discharge head.

FIG. 11 is a diagram showing an example of a main constituting element of the droplet discharge device.

### DESCRIPTION OF EXEMPLARY EMBODIMENTS

### First Embodiment

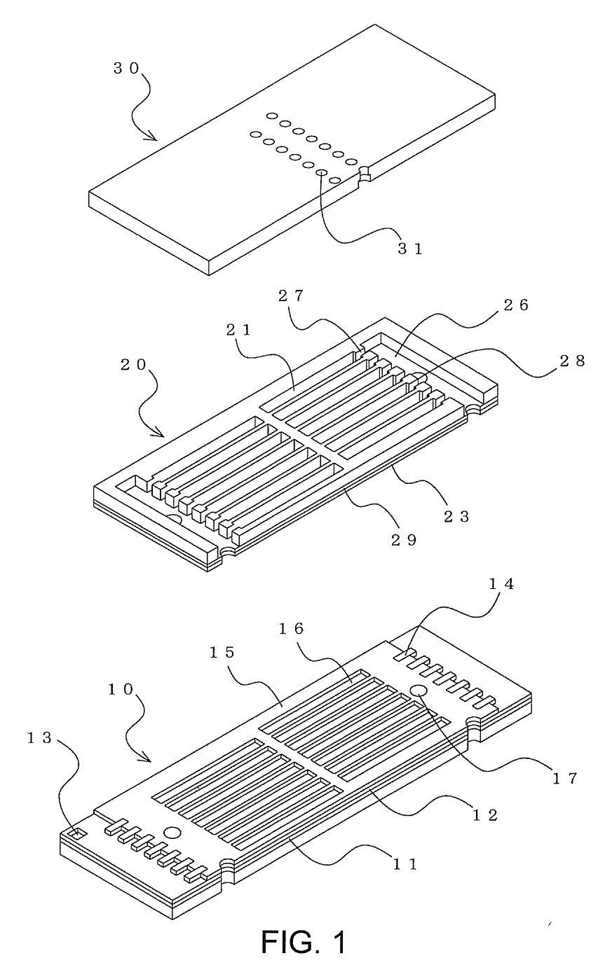

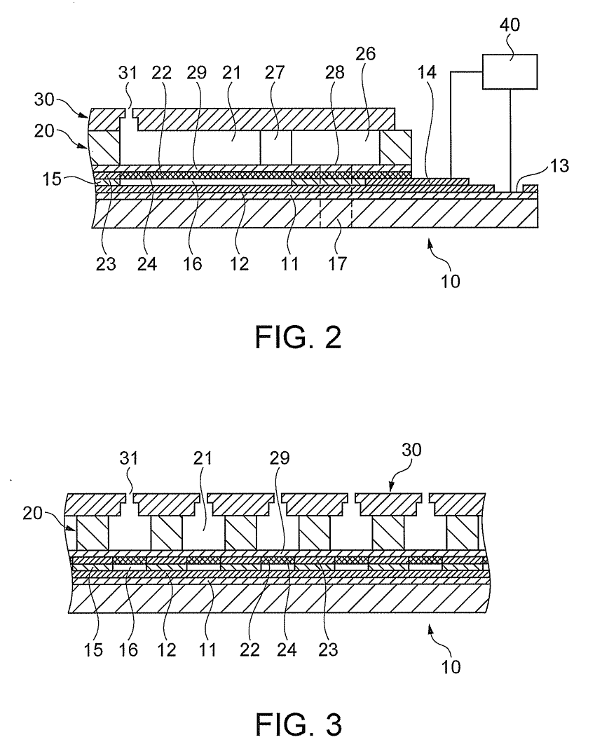

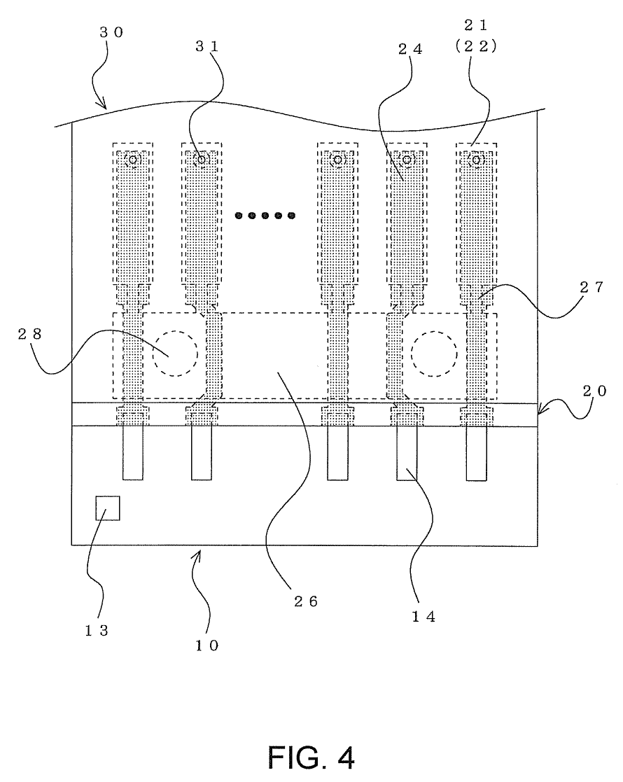

FIG. 1 is an exploded perspective view showing a droplet discharge head according to a first embodiment of the invention. FIG. 2 is a longitudinal sectional view of the droplet discharge head. FIG. 3 is a longitudinal sectional view of the droplet discharge head in the widthwise direction. FIG. 4 is a top view of the droplet discharge head. The droplet discharge head of the first embodiment is described below with reference to FIGS. 1 to 4.

FIGS. 1 to 4 show a part of the droplet discharge head. FIGS. 1 to 4 also may show components in different sizes from the actual ones for better understanding of the drawings. In the following description, directions are described as follows: the top side in FIG. 1 is an up or upper side, the bottom side in FIG. 1 is a down or lower side, a direction in which nozzles 31 are arranged is a widthwise direction of the droplet discharge head, and a direction in which liquid flowing paths are formed to the nozzles is a longitudinal direction of the droplet discharge head.

The droplet discharge head of the first embodiment, which is classified as a face-eject type droplet discharge head, includes an electrode substrate 10, a cavity substrate 20, and a nozzle substrate 30 that are layered from a down-to-up direction in this order. The electrode substrate 10 and the cavity substrate 20 are joined by anodic bonding, for example. The cavity substrate 20 and the nozzle substrate 30 are joined with an adhesive such as an epoxy resin adhesive.

The cavity substrate 20 is primarily made of nickel (Ni), for example. The cavity substrate 20 has a recessed section (its bottom wall serves as a vibration plate 22) serving as a discharge chamber 21, and a reservoir recessed section serving as a reservoir 26 that are formed on an upper surface thereof. The recessed section serving as the discharge chamber 21 and the reservoir recessed section serving as the reservoir 26 communicate with a recessed section serving as an orifice 27. The reservoir recessed section serving as the reservoir 26 has a through hole 28 through which the recessed section serving as the reservoir 26 and a liquid supply inlet 17 are communicated. The liquid supply inlet 17 is described later.

The cavity substrate 20 has an individual electrode 24 having a thickness of 0.8 μm, for example, on a lower surface thereof (that faces the electrode substrate 10). The individual electrode 24 is the bottom wall of the recessed section serving as the discharge chamber 21, and functions as the vibration plate 22. The individual electrode 24 is formed by doping boron into single-crystalline silicon to be a boron-doped layer, and its end is extended to a side edge section of the cavity substrate 20. The vibration plate 22 is made by single-crystalline silicon having superior physical property by using semiconductor processes with high accuracy fabrication.

As a result, a droplet discharge head can be provided that has good discharge characteristics and excellent driving durability.

The cavity substrate 20 also has a SiO₂ film (e.g., TEOS film) serving as an insulation layer 23 and having a thickness of 0.8 μm, for example, on the lower surface thereof in an area in which the individual electrode 24 is not formed. In other words, the insulation layer 23 is formed between the individual electrodes 24 with the same thickness of the individual electrode 24. The width of the insulation layer 23 formed in an area facing a partition wall between the discharge chambers 21 (i.e., area between the individual electrodes 24) is larger than that of the partition wall. In the first embodiment, while the insulation layer 23 is made of SiO₂, the layer may be made of aluminum oxide (alumina) such as Al₂O₃. The insulation films described hereinafter also may be made of aluminum oxide. A protective layer 29 is formed on the upper surfaces of the individual electrodes 24 and the insulation layer 23. The protective layer 29, thus, prevents the individual electrodes 24 and the insulation layer 23 from being eroded by liquid. Since the protective layer 29 is formed, the degree of freedom for selecting liquid is increased. Here, in the cavity substrate 20, recessed sections serving as the discharge chamber 21, the reservoir 26, and the orifice 27 are formed on an upper surface of the protective layer 29 with nickel (Ni) deposited by electroforming.

The electrode substrate 10 is primarily made of heat resistant hard glass such as borosilicate glass and has a thickness of 1 mm, for example. While, the electrode substrate 10 is a glass substrate in the first embodiment, but may be a single-crystalline silicon substrate, for example. A common electrode 11 is formed on an upper surface of the electrode substrate 10 at least in an area facing the vibration plate 22. The common electrode 11 is formed to have a thickness of 0.1 μm by depositing indium tin oxide (ITO) transparent in a visible light range. The material for the common electrode 11 is not limited to ITO, but metal such as chromium may also be used. However, the main reason why ITO is used in the first embodiment is that the inside of the gap is easily observed, and whether discharge occurs or not is easily confirmed due to its transparency.

A SiO₂ film serving as a common electrode side insulation layer 12 is formed on an upper surface of the common electrode 11 with a thickness of 0.1 μm. The common electrode side insulation layer 12, thus, electrically insulates the vibration plate 22 from the common electrode 11 so as to prevent an insulation film breakdown and a short from occurring when the droplet discharge head is driven. Part of the common electrode side insulation layer 12 is opened so as to expose the common electrode 11 under thereof. The exposed part of the common electrode 11 serves as a common electrode terminal 13, through which the common electrode 11 is coupled to a driver IC 40.

An individual electrode lead section 14 to couple the individual electrode 24 with the driver IC 40 is formed on an upper surface of the common electrode side insulation layer 12. The individual electrode lead section 14 is made of a metal film (e.g., a multilayered film composed of aluminum, copper, gold, and chromium) having a thickness of 0.1 μm, for example. One end of the individual electrode lead section 14 is coupled to the individual electrode 24 while the other end is protruded outside from the cavity substrate 20 in a state in which the electrode substrate 10 and the cavity substrate 20 are joined. As a result, the individual electrode 24 and the driver IC 40 are readily coupled.

A SiO₂ film serving as a spacer layer 15 is formed on the upper surface of the common electrode side insulation layer 12 with a thickness of 0.1 μm in an area in which the individual electrode lead section 14 is not formed, for example. The spacer layer 15 has an opening 16 in an area facing the recessed section serving as the discharge chamber 21. In the state in which the electrode substrate 10 and the cavity substrate 20 are joined, the opening 16 of the spacer layer 15 forms a gap between the vibration plate 22 and the common electrode 11. That is, the thickness of the spacer layer 15 corresponds to a gap length. The opening 16 of the spacer layer 15 corresponds to an electrode-forming recessed section of a related art droplet discharge head. The gap length much influences the discharge characteristics. While the spacer layer 15 is formed on the electrode substrate 10 in the first embodiment, the spacer layer 15 may be formed on the lower surface of the cavity substrate 20. Providing the spacer layer 15 on the lower surface of the cavity substrate 20 allows the electrode substrate 10 and the cavity substrate 20 to be easily positioned when they are joined. The electrode substrate 10 also has the liquid supply inlet 17 to supply a liquid supplied from an external tank (not shown) to the reservoir 26.

The nozzle substrate 30, which is made of silicon having a thickness of 180 μm, for example, is joined to the cavity substrate 20 with the lower surface. The nozzle substrate 30 has the nozzles 31 communicating with the discharge chambers 21. Each of the nozzles 31 discharges a liquid pressurized by displacement of one of the vibration plates 22 outside as a droplet. In the first embodiment, holes of the nozzles 31 are formed in a plurality of stages so as to improve straight flying property of discharged droplets. Although it is described that the nozzle substrate 30 having the nozzle hole 31 is located on the electrode substrate 10, the nozzle substrate 30 is mostly located under the electrode substrate 10 in actual use.

Explanation on Operation

The operation of the droplet discharge head of the first embodiment is described.

A liquid supplied from an external tank (not shown) flows into the liquid supply inlet 17 and through the through hole 28, the reservoir 26, and the orifice 27 to be stored in the discharge chamber 21. The individual electrode 24 (the vibration plate 22), which is the bottom wall of the discharge chamber 21, is bent by a voltage applied thereto. The bending of the individual electrode 24 (the vibration plate 22) increases pressure inside the discharge chamber 21, resulting in droplets being discharged from the nozzle 31.

The driver IC 40 controls applying a voltage to the individual electrode 24. Using an oscillation at 24 kHz, pulse potentials of 0 V and 30 V are applied to the individual electrode 24 to supply electric charges. If the individual electrode 24 (the vibration plate 22) is charged with positive charges by supplied electric charges, relatively, the common electrode 11 is charged with negative charges. The individual electrode 24 (the vibration plate 22) is bent by being attracted to the common electrode 11 with electrostatic force. This bending increases the volume of the discharge chamber 21. When electric charge supply to the common electrode 11 is stopped, the individual electrode 24 (the vibration plate 22) returns to the original shape. At the same time, the volume of the discharge chamber 21 also returns to the original one, whereby a droplet equivalent to the difference in the volume of the discharge chamber 21 is discharged by the resulting generated pressure. The discharged droplet is landed on, for example, a recording paper serving as a recording object, whereby a recording is performed. Here, such method is what is called a drawing shot. There is another method what is called a pushing shot discharging a droplet by using a spring or the like. In the structure described above, the nozzle substrate 30 may be provided with a diaphragm to buffer pressure that is generated from the bending of the individual electrode 24 (the vibration plate 22) and applied to the reservoir 26.

Manufacturing Method

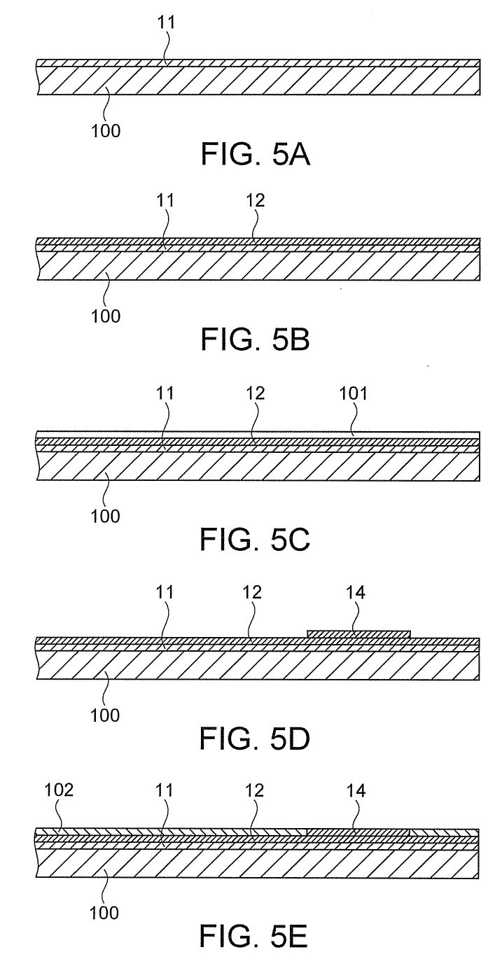

A method for manufacturing the droplet discharge head of the first embodiment is described with reference to FIGS. 5A to 9K. In the method, a single-crystalline silicon substrate 200 is joined to the electrode substrate 10, and thereafter the cavity substrate 20 is manufactured. Practically, members for a plurality of droplet discharge heads are simultaneously formed in a silicon wafer. FIGS. 5A to 9K, however, show part of the practical processes.

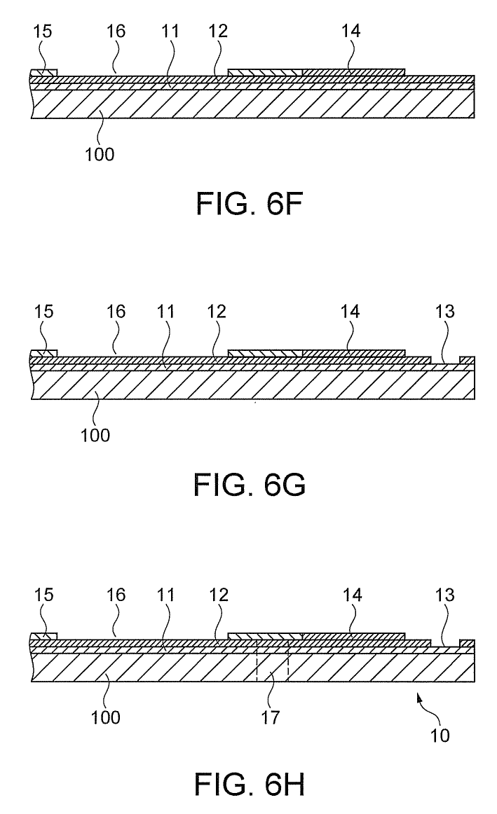

First, referring to FIGS. 5A to 6H, a method for manufacturing the electrode substrate 10 is described.

A heat resistance hard glass 100 having a thickness of 1 mm and of a borosilicate type is prepared. The upper and lower surfaces of the glass 100 are mirror polished. An ITO film serving as the common electrode 11 is formed on the upper surface of the glass 100 with a thickness of 0.1 μm by sputtering (FIG. 5A). Since the common electrode 11 is formed by sputtering, a degree of freedom for selecting material for the common electrode 11 increases. Then, a SiO₂ film serving as the common electrode side insulation layer 12 is formed with a thickness of 0.1 μm by chemical vapor deposition (CVD) (FIG. 5B). Since the common electrode side insulation layer 12 is formed by CVD, an insulation layer having high density, high breakdown voltage, and high quality can be formed.

Next, a metal film 101 serving as the individual electrode lead section 14 is formed with a thickness of 0.1 μm by sputtering (FIG. 5C). The shape of the individual electrode lead section 14 is patterned on the metal film 101 by photolithography. Then, the individual electrode lead section 14 is formed by wet etching and the like (FIG. 5D). Next, a SiO₂ film 102 serving as the spacer layer 15 is formed with a thickness of 0.1 μm by CVD (FIG. 5E). The shape of the spacer layer 15 is patterned on the SiO₂ film 102 by photolithography. Then, the spacer layer 15 is formed by wet etching and the like (FIG. 6F). As a result, the opening 16 is formed.

Next, the shape of the common electrode terminal 13 is patterned on the common electrode side insulation layer 12 by photolithography. Then, the common electrode terminal 13 is opened by wet etching and the like (FIG. 6G). Then, the heat resistance hard glass 100 is grinded by using a drill and the like so as to form the liquid supply inlet 17. As a result, the electrode substrate 10 is completed (FIG. 6H).

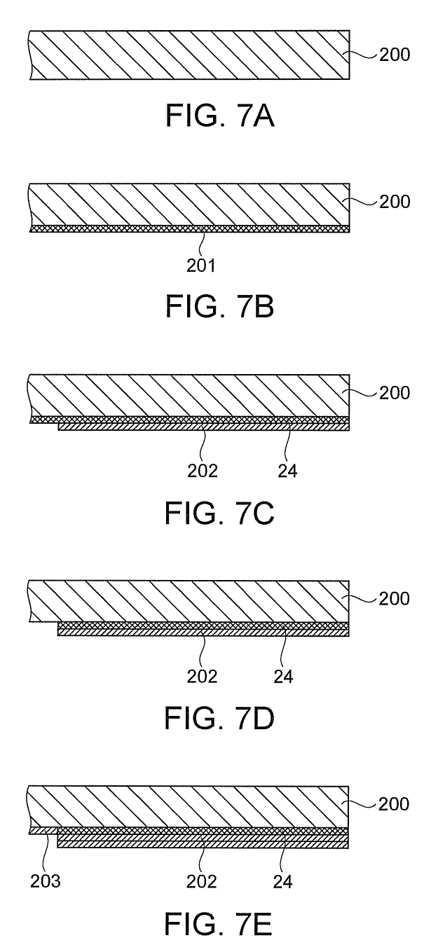

Referring to FIGS. 7A to 9K, a method for manufacturing the cavity substrate 20 and the droplet discharge head is described.

A single-crystalline silicon substrate 200 is prepared for being processed (FIG. 7A). Then, a highly boron doped layer 201 serving as the vibration plate 22 is formed on the lower surface of the single-crystalline silicon substrate 200 with a thickness of 0.8 μm by thermal diffusion (FIG. 7B). Next, the under surface of the boron doped layer 201 is coated with a resist. Thereafter; the shape of the individual electrode 24 is patterned on the resist by photolithography. Then, a resist mask 202 having the shape of the individual electrode 24 is formed by wet etching and the like (FIG. 7C). Then, the individual electrode 24 is formed by wet etching and the like (FIG. 7D). In this case, the single-crystalline silicon substrate 200 functions as a support substrate for forming the individual electrode 24 and the like until when the single-crystalline silicon substrate 200 is joined to the electrode substrate 10.

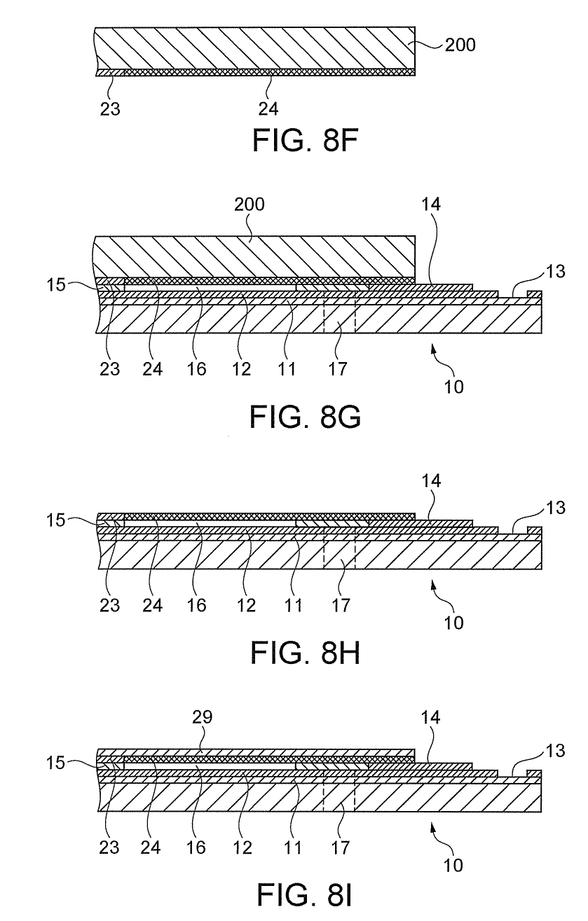

Next, a SiO₂ film 203 is formed on the lower surfaces of the single-crystalline silicon substrate 200 and the resist mask 202 with a thickness of 0.8 μm by CVD (FIG. 7E). Then, the resist mask 202, and the SiO₂ film 203 formed on the lower surface of the resist mask 202 are removed so as to form the insulation layer 23 between the individual electrodes 24 (FIG. 8F). Since the insulation layer 23 is formed as a film, it can be formed with the same thickness of the individual electrode 24. If the large step is formed between the insulation layer 23 and the individual electrode 24, polishing such as chemical polishing may be carried out.

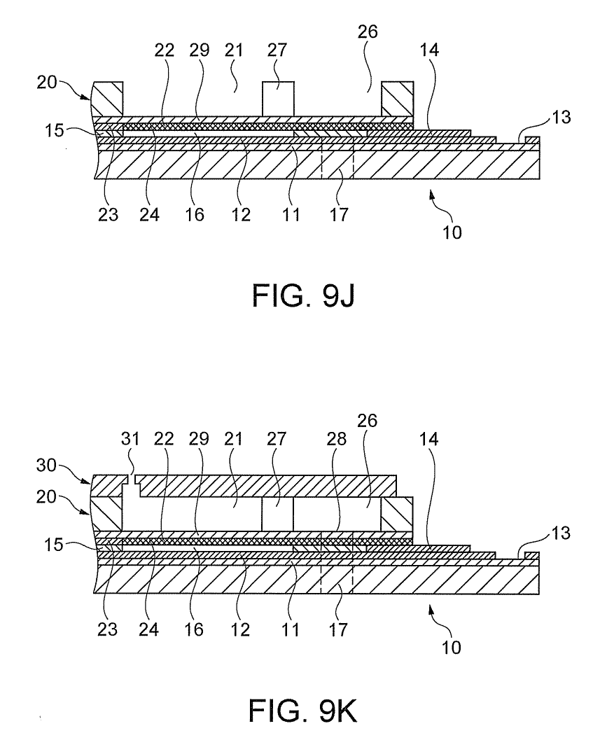

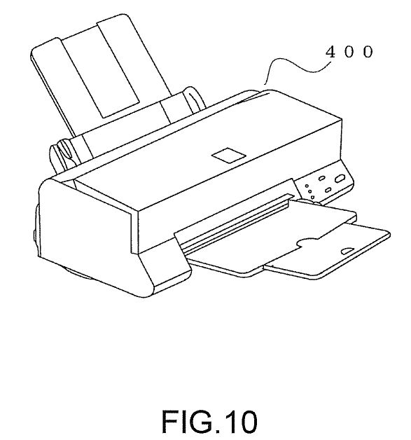

Next, the single-crystalline silicon substrate 200 and the electrode substrate 10 are joined by anodic bonding (FIG. 8G). Then, the single-crystalline silicon substrate 200 is grinded and polished from the upper surface to reduce the thickness to a thickness at which the individual electrode 24 and the insulation layer 23 are exposed (FIG. 8H). In the following steps after the single-crystalline silicon substrate 200 is polished to the desired thickness, the electrode substrate 10 functions as a support substrate. Next, an area excluding the individual electrode 24 and the insulation layer 23 is masked. Thereafter, a tantalum oxide (Ta₂O₃) film serving as the protective layer 29 is formed on the upper surfaces of the individual electrode 24 and the insulation layer 23 with a thickness of 0.1 μm (FIG. 8I). Then, nickel (Ni) is deposited on the upper surface of the protective layer 29 with a desired thickness by electroforming so as to form the partition wall of the discharge chamber 21, and the like. As a result, the recessed sections serving as the discharge chamber 21, the reservoir 26, and the orifice 27 are formed (FIG. 9J). Then, the through hole 28 is formed by using a pin and the like. Thereafter, the nozzle substrate 30 is joined on the upper surface of the single-crystalline silicon substrate 200 with an adhesive. As a result, the droplet discharge head is completed (FIG. 9K).

In the droplet discharge head structured described as above, since the spacer layer 15 is formed as a film, the gap length between the vibration plate 22 (the individual electrode 24) and the common electrode 11 can be formed with high accuracy. In addition, the opening of the space layer 15 can be formed with high accuracy. The opening corresponds to the electrode-forming recessed section in the related art droplet discharge head. Further, the insulation layer 23 provided between the individual electrodes 24 can prevent a malfunction of the droplet discharge head since electrical conduction does not occur between the individual electrodes 24 (the vibration plates 22).

The insulation layer 23 is formed between the individual electrodes 24 so that the width facing the partition wall between the discharge chambers 21 is larger than that of the partition wall. This structure can prevent electrical conduction between the individual electrodes 24 (the vibration plates 22) from occurring. As a result, the occurrence of the malfunction of the droplet discharge head can further be prevented.

The common electrode side insulation layer 12 can be formed on the surface of the common electrode 11 to have good insulation property without having any coverage defects since the common electrode 11 has the surface of a flat-shape.

The individual electrode lead section 14, which connects the individual electrode 24 to the driver IC 40, is formed on the electrode substrate 10. Because of this structure, the individual electrode 24 and the individual electrode lead section 14 can be coupled only by positioning the electrode substrate 10 and the cavity substrate 20 (the single-crystalline silicon substrate 200) and joining them. As a result, the individual electrode 24 and the driver IC 40 are readily coupled.

### Second Embodiment

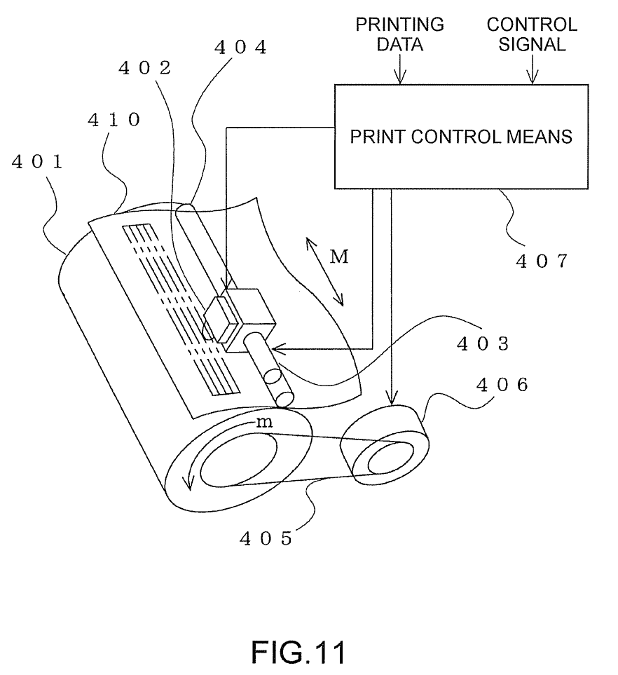

FIG. 10 is an external view showing a droplet discharge device (a printer 400) employing the droplet discharge head manufactured in the first embodiment. FIG. 11 is a diagram showing an example of a main constituting element of the droplet discharge device. The droplet discharge device of FIGS. 10 and 11 carries out printing by a droplet discharge method (an ink-jetting method). In addition, the droplet discharge device is one of what is called a serial type. As shown in FIG. 11, the droplet discharge device 400 mainly includes a drum 401 and a droplet discharge head 402. The drum 401 supports a print paper 410 that is an object to be printed. The droplet discharge head 402 discharges ink to the print paper 410 for performing a record. In addition, ink supply means (not shown) is provided for supplying ink to the droplet discharge head 402. The print paper 410 is pressed and held to the drum 401 by a paper pressing-holding roller 403 disposed in parallel to the axial direction of the drum 401. A lead screw 404 is disposed in parallel to the axial direction of the drum 401 to hold the droplet discharge head 402. The lead screw 404 rotates so as to move the droplet discharge head 402 in the axial direction of the drum 401.

On the other hand, the drum 401 is rotary driven by a motor 406 with a belt 405 and the like. A print control means 407 drives the lead screw 404 and the motor 406 based on printing data and a control signal. As described in the first embodiment, a voltage is applied to the individual electrode 24 from the driver IC 40 to vibrate the vibration plate 22 for discharging a liquid (ink), performing a print on the print paper 10.

While liquid is discharged to the print paper 410 as ink in this case, liquid discharged from the droplet discharge head is not limited to ink. A various liquids may be discharged from a droplet discharge head provided in respective devices used in the following exemplary cases. In an application where liquid is discharged to a substrate serving as a color filter, liquid containing a pigment may be used. In another application where liquid is discharged to a substrate serving as a display panel (such as OLED) using an electroluminescent element such as an organic compound, liquid containing a compound serving as an light-emitting element may be used. In another application where liquid is discharged on a substrate for forming wiring lines, liquid containing conductive metal may be used. When liquid is discharged to a substrate serving as a biomolecule micro array by using the droplet discharge head as a dispenser, liquid may be discharged that contains a probe such as deoxyribo nucleic acids (DNA), other nucleic acids such as ribonucleic acids and peptide nucleic acids, and other proteins. The device also can be used to discharge dye for clothes or the like.

What is claimed is:

1. A droplet discharge head, comprising:
a nozzle substrate having a plurality of nozzles, each of the plurality of nozzles discharging a droplet;
a cavity substrate, the cavity substrate including:
a discharge chamber communicating with the nozzle and having a vibration plate formed at part thereof;
an individual electrode formed to the vibration plate, the individual electrode being provided in a plurality of numbers so that each individual electrode corresponds to one of the nozzles; and
an insulation layer formed between the individual electrodes;
an electrode substrate having a common electrode formed at a position facing the vibration plate; and
a member sandwiched between the cavity substrate and the electrode substrate so as to form a gap.

2. The droplet discharge head according to claim 1, wherein: the discharge chamber includes a plurality of discharge chambers; and a width of the insulation layer is larger than a width of a wall between the plurality of the discharge chambers.

3. The droplet discharge head according to claim 1, wherein the common electrode has a common electrode side insulation layer formed on a surface thereof, and the common electrode side insulation layer prevents an electrical coupling between the individual electrode and the common electrode from occurring.

4. The droplet discharge head according to claim 3, wherein the electrode substrate has a face facing the cavity substrate, and the face has a lead section formed thereon so as to be coupled to the individual electrode in a state in which the electrode substrate and the cavity substrate are joined.

5. A droplet discharge device comprising the droplet discharge head according to claim 1.

6. A method for manufacturing the droplet discharge head according to claim 1, comprising:
forming the individual electrode in a plurality of numbers to a face of the cavity substrate, the face facing the electrode substrate;
forming the insulation layer between the individual electrodes;
forming the common electrode and a spacer layer to a face of the electrode substrate, the surface facing the cavity substrate; and
joining the cavity substrate and the electrode substrate.
